(19) United States
(12) Patent Application Publication
(10) Pub. No.: US 2005/0285781 A1
(43) Pub. Date: Dec. 29, 2005

(54) GPS receiver and method for detecting a jammer signal using fast fourier transform

(75) Inventors: Chan-Woo Park, Seoul (KR); Sun Choi, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/110,803

(22) Filed: Apr. 21, 2005

(30) Foreign Application Priority Data
Jun. 29, 2004 (KR) 2004-49750

(51) Int. Cl. G01S 5/14

(52) U.S. Cl. 342/357.02

(57) ABSTRACT

A global positioning system (GPS) receiver and method are provided for detecting a jammer signal using fast Fourier transform (FFT). A correlator correlates GPS signals received from GPS satellites with codes based on a plurality of carrier frequency signals having predetermined frequency offsets therebetween, and computes n correlated samples associated with each of the GPS satellites. A memory stores the n correlated samples associated with each of the GPS satellites and n FFT bins corresponding thereto. A FFT processor transforms the n correlated samples read from the memory using n-point FFT to obtain the n FFT bins, and transfers the n FFT bins to the memory. A peak detector detects largest peaks exceeding a lowered detection threshold from the FFT bins associated with each of the GPS satellites. A jammer detection unit makes a determination as to whether a peak relatively far away from other peaks is present among the largest peaks, and detects a signal of a peak far away from other peaks.

### PRIORITY

This application claims priority to an application entitled “GPS RECEIVER AND METHOD FOR DETECTING A JAMMER SIGNAL USING FAST FOURIER TRANSFORM”, filed in the Korean Intellectual Property Office on Jun. 29, 2004 and assigned Serial No. 2004-49750, the entire contents of which are incorporated herein by reference.

### BACKGROUND OF THE INVENTION

1. Field of the Invention

The present invention relates generally to a global positioning system (GPS). More particularly, the present invention relates to a GPS receiver and method for detecting GPS signals in an environment in which intensities of the GPS signals received from GPS satellites are very low.

2. Description of the Related Art

With the development of technology, personal portable communication is rapidly developing, and various supplementary services are being supported. Some countries have enacted laws stating that mobile terminals must be equipped with a global positioning system (GPS) device. It is a trend that various location-based services are providing to many mobile terminals. Many GPS satellites broadcast ephemeris and system time information while orbiting the earth, such that GPS receivers can determine their positions. The GPS receivers can accurately determine their positions by computing the arrival times of GPS signals simultaneously transmitted from at least four satellites.

This procedure requires several minutes. More specifically, a compact GPS receiver with a limited amount of battery power cannot perform the above-mentioned procedure for a long period of time. Accordingly, some GPS receivers receive, from an assisted GPS (AGPS) server, basic Doppler information, that is, coarse code phase values and coarse Doppler values, necessary for a search. Multiple satellites must be able to simultaneously observe a GPS receiver, and the GPS receiver must receive high-quality signals from the satellites. Because many portable or mobile devices may not be equipped with high-quality antennas, and/or may be located within forested areas and buildings, it is not easy for the portable devices to receive high-quality signals.

A typical GPS does not use a pilot channel in which no data bit is modulated, but can remove a data bit by making use of a predicted data bit provided from the AGPS server. An improved coarse acquisition (C/A) code of an L2 band can use unmodulated data. Because unmodulated signals can be coherently integrated for a long time, it is very important that reception sensitivity be improved through coherent integration of GPS signals with weak signal intensities.

An application of an accurate Doppler frequency is essential in the coherent integration for the long time. More specifically, because a frequency error generated from a local oscillator (LO) or a Doppler offset due to user motion lowers a correlation energy value in time consuming coherent integration, it makes signal acquisition difficult.

FIG. 1 is a block diagram illustrating a conventional GPS receiver 100 for detecting a GPS signal. The GPS receiver 100 has a relatively compact structure such that it can be mounted to a mobile phone, remote communication device, or portable device.

Referring to FIG. 1, an antenna 102 receives a radio frequency (RF) signal from a GPS satellite, and a RF receiver 104 converts the received RF signal into an intermediate frequency (IF) signal. An analog-to-digital (A/D) converter 106 converts the IF signal into a digital signal and then outputs the digital signal to a mixer 108. The mixer 108 mixes a carrier frequency signal with the digital signal and then outputs a result of the mixing to a correlator 120.

A carrier numerically controlled oscillator (NCO) 114 and a code NCO 116 compensate for phase errors of a code and a carrier according to relative position (or speed) variation. The GPS receiver 100 can further include an AGPS receiver (not illustrated) for receiving coarse Doppler information and other signal parameters from an AGPS server. The Doppler information and the parameters received from the AGPS server are provided to the carrier NCO 114, a code generator 118, and the code NCO 116.

The carrier NCO 114 generates a carrier frequency signal appropriate for a Doppler search using an oscillation signal provided from a temperature-compensated crystal oscillator (TCXO) 112, and then provides the carrier frequency signal to the mixer 108. The code NCO 116 associated with the GPS satellite generates a code frequency signal in which phase has been corrected at a carrier frequency. The code generator 118 generates a pseudo random noise (PRN) code of the GPS signal in response to the code frequency signal. The correlator 120 correlates a signal output from the mixer 108 with the PRN code to obtain a correlated sample. Correlated samples are accumulated for approximately 1 msec, and a result of the accumulation corresponds to a result of 1-msec coherent integration.

A Doppler frequency generated due to relative motion between the GPS satellite and the GPS receiver 100 influences peak values of the correlated samples. This influence is not completely removed by the carrier NCO 114 alone. Accordingly, the GPS receiver 100 controls the carrier NCO 114 for the Doppler search. That is, the carrier NCO 114 outputs the carrier frequency signal while varying the carrier frequency by a predetermined frequency offset within a predetermined Doppler search range. The correlated samples based on carrier frequency signals are stored in a memory, i.e., random access memory (RAM), 122.

A coherent integrator 124 reads samples from the memory, accumulates the samples by the number of coherent integrations, and coherently integrates the accumulated samples. A signal detector 126 detects a correlated sample with peak energy greater than a predetermined detection threshold value from correlated samples output by the coherent integrator 124. A carrier frequency with the peak energy is regarded as a Doppler frequency.

An accurate Doppler frequency needs to be applied such that sufficient correlation energy for signal acquisition can be obtained according to an increased coherent integration period when a predetermined Doppler search range is given. Doppler search resolution must be increased according to the increased coherent integration period such that an accurate Doppler frequency can be detected by signal detector 128. A relationship between the coherent integration period and the search resolution is defined in Equation 1. That is, when a Doppler rate is 0, a relation between the correlation energy and the frequency error is expressed by Equation 1:

$$I = AR ( τ ) {\int }_{- T / 2}^{T / 2} cos ( \partial ω T + \partial θ ) ⅆ t + n = AT \cdot R ( τ ) \frac{sin ( \partial ω T / 2 )}{\partial ω T / 2} cos ( \partial θ ) + n \qquad ( 1 )$$

In Equation 1, I is the magnitude of correlation energy, A is the amplitude of correlation energy according to a signal-to-noise ratio (SNR), and n is correlation noise. In Equation 1, R(τ) is a correlation function associated with a code phase error of τ chips, ∂ω is 2π∂f where δf is a frequency error (Hz), T is a coherent integration period (seconds), and ∂θ is a phase error (radians).

Variation of the correlation energy magnitude according to a frequency error when coherent integrations are performed for 16 msec and 64 msec using Equation 1, is illustrated in FIG. 2. In FIG. 2, reference numeral 10 denotes correlation energy based on the 16-msec coherent integration, and reference numeral 12 denotes correlation energy based on the 64-msec coherent integration. As illustrated in FIG. 2, the magnitude of correlation energy is normalized to 1 at the frequency error of 0.

As illustrated in FIG. 2, an influence of the frequency error on the correlation energy increases when the coherent integration period increases. A frequency in which the correlation energy becomes zero for the first time according to an increase of the frequency error is 62.5 Hz in case of a 16-msec coherent integration, and 15.625 Hz in case of a 64-msec coherent integration. When an unknown frequency error is present, the search resolution must be at least 31.25(=62.5/2) Hz in case of a 16-msec coherent integration and must be at least 7.8125 (=15.625/2) Hz in case of a 64-msec coherent integration such that sufficient correlation energy for signal acquisition can be obtained.

To obtain the above-mentioned search resolution, the GPS receiver 100 of FIG. 1 performs a time domain search by performing n number of coherent integrations on 1-msec samples (in a coherent integration period=n msec) and shifting a carrier frequency 2n times such that a Doppler search range of up to 1000 Hz can be satisfied. In this case, the carrier NCO 114 needs to consecutively output signals at 31.25 Hz (in the 16-msec coherent integration period) or 7.8125 Hz (in the 64-msec coherent integration period) such that a search is performed. When the search range is wide, a search time rapidly increases. For example, when the search range is up to 1000 Hz and the 64-msec coherent integration must be performed, an NCO frequency must be changed 128 (=1000/7.8125) times such that the search can be performed. In this case, the total search time is a significantly long time of 8.192 sec (=1000/7.8125*0.064). More specifically, when a PRN code is searched for, a search time rapidly increases.

To reduce delay time, a GPS receiver uses fast Fourier transform (FFT) technology. This GPS receiver transforms a GPS signal using FFT and searches for a Doppler frequency. The GPS receiver requires a large number of FFT operations and thus requires an increased number of hardware channels to obtain high reception sensitivity and high processing rate using FFT based on the limited number of FFT points. There is a problem in that the conventional GPS receiver with the limited number of channels cannot perform coherent integration for more than 20 msec.

### SUMMARY OF THE INVENTION

Accordingly, the present invention has been designed to solve the above and other problems occurring in the prior art. Therefore, it is an aspect of the present invention to provide a global positioning system (GPS) receiver and method that can obtain sufficient correlation energy for signal acquisition by compensating for a frequency error as an obstacle to using time consuming coherent integration to improve reception sensitivity.

It is another aspect of the present invention to provide a global positioning system (GPS) receiver and method that perform coherent integration using fast Fourier transform (FFT) with a number of FFT points corresponding to a coherent integration period.

The above and other aspects of the present invention can be achieved by a method for detecting a jammer signal using fast Fourier transform (FFT) in a global positioning system (GPS) receiver, comprising correlating GPS signals received from GPS satellites with codes based on a plurality of carrier frequency signals having predetermined frequency offsets therebetween, and computing n correlated samples associated with each of the GPS satellites and transforming the n correlated samples associated with each of the GPS satellites using n-point FFT to output n FFT bins. The method further comprises detecting largest peaks exceeding a lowered detection threshold from the FFT bins associated with each of the GPS satellites and making a determination as to whether a peak relatively far away from other peaks is present among the largest peaks, and detecting, as a jammer signal, a signal of a peak far away from other peaks.

The above and other aspects of the present invention can be achieved by a global positioning system (GPS) receiver for detecting a jammer signal using fast Fourier transform (FFT), comprising a correlator for correlating GPS signals received from GPS satellites with codes based on a plurality of carrier frequency signals having predetermined frequency offsets therebetween, and computing n correlated samples associated with each of the GPS satellites and a memory for storing the n correlated samples associated with each of the GPS satellites and n FFT bins corresponding thereto. The apparatus further comprises a FFT processor for transforming the n correlated samples read from the memory using n-point FFT to obtain the n FFT bins, and transferring the n FFT bins to the memory, a peak detector for detecting largest peaks exceeding a lowered detection threshold from the FFT bins associated with each of the GPS satellites and a jammer detection unit for making a determination as to whether a peak relatively far away from other peaks is present among the largest peaks, and detecting, as a jammer signal, a signal of a peak far away from other peaks.

### BRIEF DESCRIPTION OF THE DRAWINGS

The above and other aspects and advantages of the present invention will be more clearly understood from the following detailed description taken in conjunction with the accompanying drawings, in which:

FIG. 1 is a block diagram illustrating a conventional global positioning system (GPS) receiver for detecting a GPS signal;

FIG. 2 is a graph illustrating magnitude variation of correlation energy according to a frequency error when coherent integrations are performed for 16 msec and 64 msec;

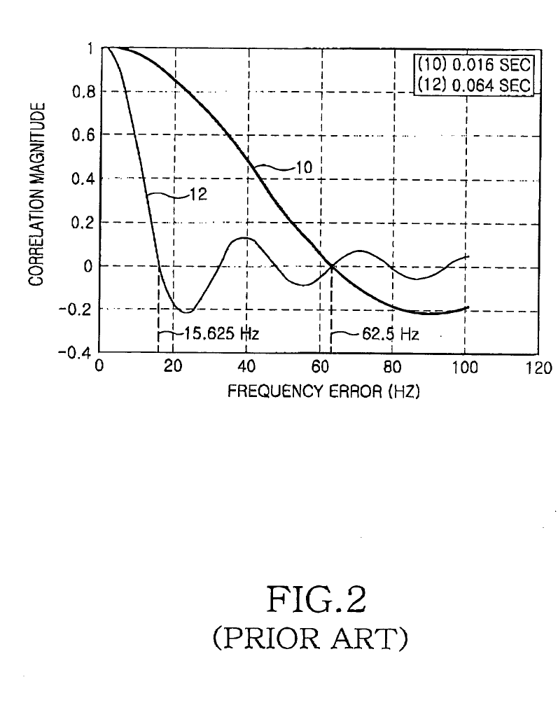

FIG. 3 illustrates a GPS receiver with a communication link in accordance with an embodiment of the present invention;

FIG. 4 is a block diagram illustrating details of the GPS receiver in accordance with an embodiment of the present invention; and

FIG. 5 is a graph illustrating accumulated correlation values measured on 64-point fast Fourier transform (FFT) bins receiver in accordance with an embodiment of the present invention.

Throughout the drawings, the same element is designated by the same reference numeral or character.

### DETAILED DESCRIPTION OF EXEMPLARY EMBODIMENTS

Embodiments of the present invention will be described in detail herein below with reference to the accompanying drawings. In the following description, a detailed description of known functions and configurations incorporated herein will be omitted for conciseness. It is to be understood that the phraseology and terminology herein are for the purpose of description and should not be regarded as limiting.

The present invention uses fast Fourier transform (FFT) with the number of FFT points corresponding to a coherent integration period (msec) when a Doppler frequency is searched for from correlation (accumulation) result samples of 1 msec such that a global positioning system (GPS) signal of a low intensity can be acquired and tracked. Accordingly, coherent integration can be performed by the number of FFT points using a small number of channels and resources. Reception sensitivity can be improved using a frequency offset generated from a local oscillator (LO).

A GPS receiver of the present invention performs n-point FFT on accumulation result samples consecutive in units of 1 msec such that n-msec coherent integration can be performed. When a FFT operation on samples collected for n msec is performed, frequency search resolution of 1000/n Hz can be obtained from a value of n-msec coherent integration. This frequency search resolution of 1000/n Hz corresponds to the half value of search resolution, i.e., 1000/2n Hz, required for n-msec coherent integration. Accordingly, two hardware channels per satellite are required or a search time per satellite needs to be doubled.

The present invention detects a jammer signal using a satellite-by-satellite difference between LO biases generated by FFT with high resolution. Accordingly, a detection threshold used to detect a jammer signal is lowered by 3 dB, and n-msec coherent integration and a Doppler frequency search of resolution necessary therefor are performed using only one hardware channel per satellite.

The GPS receiver must correlate GPS signals in real time. When a portable or mobile device with limited hardware resources performs a complex computation for determining a carrier and code of a GPS signal, it places a heavy burden on the processor and power system, and a very long time is taken to perform the complex computation. GPS receivers of conventional portable or mobile devices receive coarse parameters necessary to search for GPS signals from an adjacent server equipped with a GPS receiver using a separate data communication function. This system is referred to as the assisted-GPS (AGPS), and the server is referred to as the AGPS server.

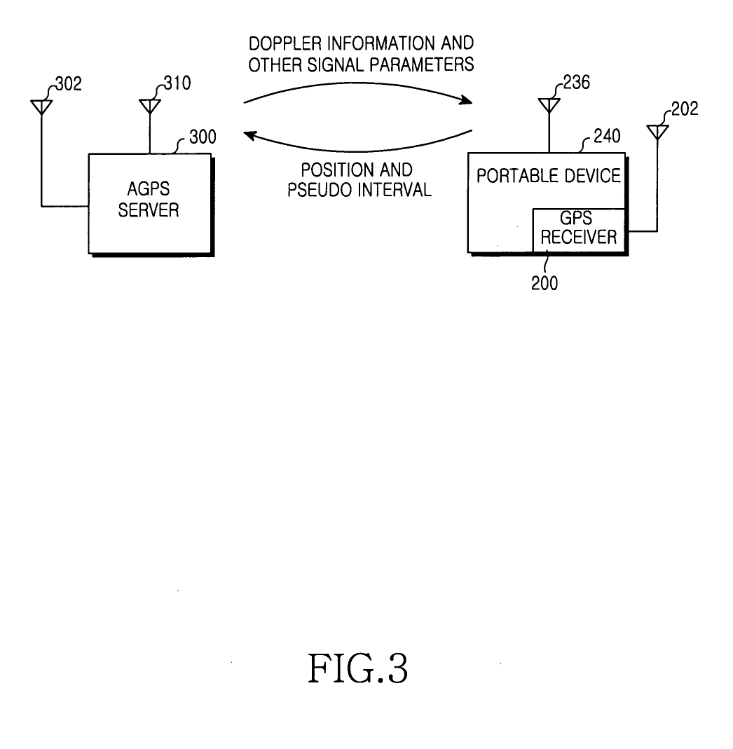

FIG. 3 illustrates a GPS receiver with a communication link to which the present invention is applied. The GPS receiver provided in a portable or mobile device 240 has a system structure for receiving parameters necessary to search for a GPS signal from an AGPS server 300.

Referring to FIG. 3, the portable device 240 communicates with the AGPS server 300 by means of a unique communication technique. The AGPS server 300 is located adjacent to the portable device 240, and is associated with the same GPS satellites as those used by the portable device 240. Accordingly, the AGPS server 300 receives GPS signals from the GPS satellites using a GPS antenna 302, roughly determines Doppler information and other signal parameters of the GPS satellites on the basis of the GPS signals, includes a result of the determination in an AGPS message, and outputs the AGPS message to the portable device 240 through an antenna 310.

The portable device 240 receives the AGPS message using an antenna 236. The GPS receiver 200 provided in the portable device 240 searches for the GPS signals received through a GPS antenna 202 within a code and carrier search range roughly determined according to the Doppler information included in the AGPS message, and the like.

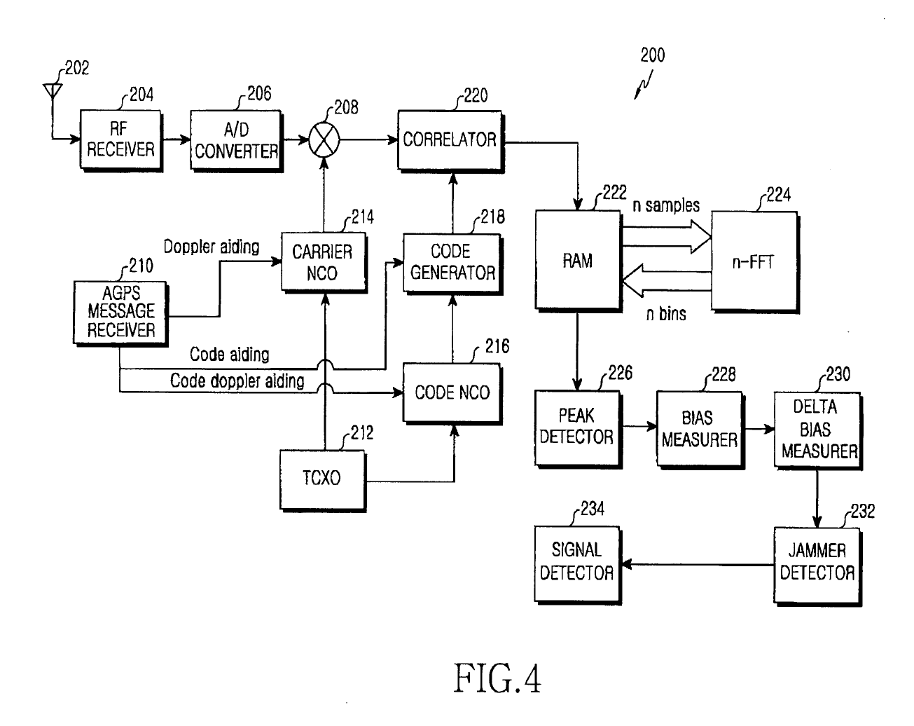

FIG. 4 is a block diagram illustrating details of the GPS receiver 200 in accordance with an embodiment of the present invention. The GPS receiver 200 receives Doppler information, etc. through a communication link illustrated in FIG. 3 or another communication link.

Referring to FIG. 4, the GPS receiver 200 includes an AGPS message receiver 210, a carrier numerically controlled oscillator (NCO) 214, a code NCO 216, a correlator 220, a RF receiver 204, a memory, such as random access memory (RAM), 222 for storing n number of accumulated 1-msec samples or n-point FFT bins to perform n-msec coherent integration, a n-FFT processor 224 for performing an n-point FFT operation, and a signal detector 234. The GPS receiver 300 further includes a peak detector 226 and a jammer detection unit including a LO bias measurer 228, a delta bias measurer 230, and a jammer detector 232.

The antenna 202 receives a RF signal transmitted from the GPS satellite. The RF receiver 204 converts the RF signal into an intermediate frequency (IF) signal. An analog-to-digital (A/D) converter 206 converts the IF signal into a digital signal, and then transfers the digital signal to a mixer 208. The mixer 208 mixes the digital signal with a carrier frequency signal and then outputs a result of the mixing to a correlator 220.

The carrier NCO 214 and the code NCO 216 compensate for a carrier phase error and a code phase error according to relative position (speed) variation of the GPS receiver 200, respectively. That is, the AGPS message receiver 210 receives an AGPS message from the AGPS server (denoted by reference numeral 300 in FIG. 3) through a unique communication link, and extracts coarse Doppler information and other signal parameters from the AGPS message. The Doppler information can be a Doppler shift value. The carrier NCO 214 refers to the Doppler information using an oscillation signal provided from a temperature-compensated crystal oscillator (TCXO) or LO 212, and generates a carrier frequency signal within a range appropriate for a Doppler search. Similarly, the code NCO 216 refers to the Doppler information and generates an appropriate code frequency signal according to a carrier frequency. A code generator 218 generates a pseudo random noise (PRN) code of a GPS signal according to the code frequency signal. The correlator 220 correlates the PRN code with a signal output from the mixer 208, and produces a correlated sample corresponding to a 1-msec GPS signal.

The carrier NCO 214 sequentially outputs a plurality of carrier frequency signals in which a predetermined frequency offset is present between the carrier frequency signals. The frequency offset is associated with frequency resolution. A plurality of correlated samples corresponding to the plurality of carrier frequency signals are generated by the code NCO 216, the code generator 218, and the correlator 220, such that the generated samples are sequentially stored in the memory 222.

In the specification of the present invention, the term “1-msec sample” refers to a result of correlation between a 1-msec digital sample and a PRN code. In this case, the memory 222 sequentially stores n number of 1-msec samples such that n-msec coherent integration is performed where n is 2^{k} and k is an integer. When the memory 222 is filled with the n samples, the n-point FFT processor 224 receives the n samples, performs an FFT operation on the received samples, and stores FFT bins in the memory 222. The FFT bins correspond to specific frequency components, and have frequency resolution of 1000/n Hz. The frequency resolution of 1000/n Hz corresponds to the half value of frequency resolution of 1000/2n Hz required to accurately detect a desired GPS signal. Table 1 describes the maximum frequency error and the maximum signal power loss according to the frequency resolution.

TABLE 1

| | Max Frequency | Max Signal Power |
|---|---|---|
| Resolution [Hz] | Error [Hz] | Loss [dB] |
| 1000/n | 1000/(2*n) | ˜4 |
| 1000/2n | 1000/(4*n) | ˜0.9 |

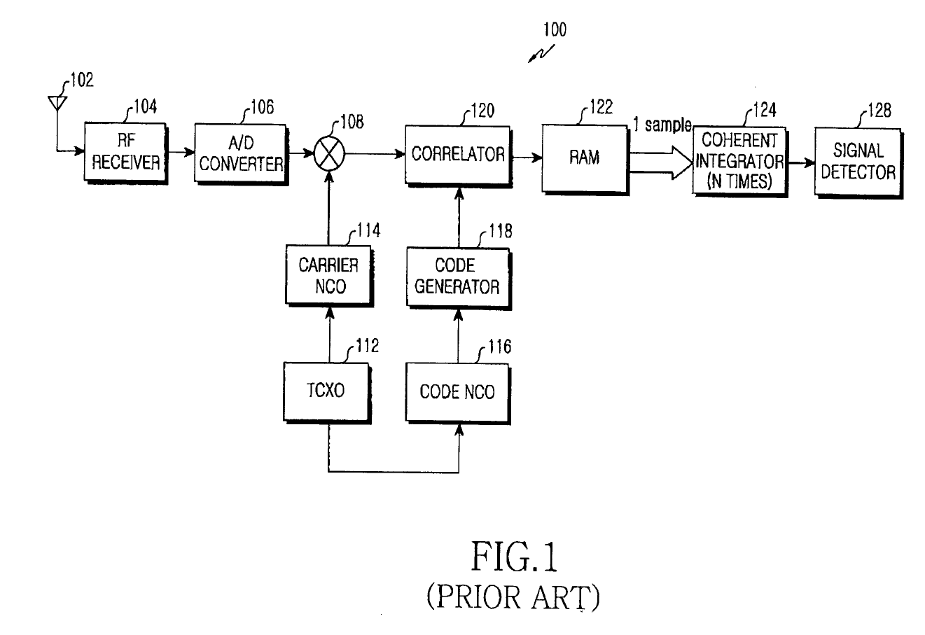

According to Table 1, the frequency resolution necessary to satisfy a signal loss of less than 1 dB is 1000/2n in a conventional communication system. To obtain the desired frequency resolution, the conventional GPS receiver illustrated in FIG. 1 performs 2n search operations using 2n parallel hardware channels, thereby obtaining the desired frequency resolution.

To double the frequency resolution associated with FFT bins obtained from the n-point FFT, an embodiment of the present invention lowers a detection threshold of the peak detector 226 by ½. Because the resolution of 1000/n has additional signal loss of 3 dB as compared with the desired minimum signal loss of 1 dB as seen in Table 1, the detection threshold of the GPS receiver of FIG. 3 is 3 dB less than that of the GPS receiver of FIG. 1. When the detection threshold is lowered, a Doppler frequency is incorrectly detected and thus the probability of generating a false alarm increases. To remove the false alarm, a Doppler bias is used. The term “Doppler bias” refers to a difference between a predicted Doppler center determined by the Doppler information of the AGPS message and a Doppler frequency of a detected peak.

When the peak detector 226 detects peaks exceeding a lowered detection threshold from a plurality of satellite signals, the bias measurer 228 measures Doppler frequencies of the detected peaks and produces a bias of the Doppler frequencies, that is, a Doppler bias. The Doppler bias is determined by two factors. The first factor is a Doppler bias generated by an offset of the LO 212, that is, an LO offset, and the Doppler bias is referred to as an LO bias. The second factor is a user Doppler bias generated by user motion. Doppler Bias i associated with Satellite i is a sum of the LO bias and User Doppler Bias i.

However, because a change of the user motion is small when a portable device is used in an indoor area, the effect of the user Doppler bias due to the user motion is negligible. When the user drives a car with the portable device and moves at a high speed, the effect of the user Doppler bias must be taken into account. In this case, because the portable device is used in an outdoor area, the GPS receiver can receive GPS signals of relatively strong intensities from the GPS satellites. The GPS signals can be detected without performing time consuming coherent integration and FFT.

When the user Doppler bias is negligible, the Doppler bias is produced by a difference between a Doppler frequency of each satellite and a Doppler center predicted satellite by satellite. Because all satellite signals are received using a common local oscillation clock, they ideally have the same Doppler bias. However, because an error of a predicted Doppler value, a Doppler measurement error due to FFT frequency resolution, and a Doppler frequency shift due to slight motion of a user are present, the Doppler bias has a slight error around the common Doppler bias. Accordingly, detected signals may not have a common bias due to a false alarm or jamming. In this case, the bias measurer 228 computes a common bias according to detected peaks. For example, the common bias is an average of Doppler biases associated with several higher peaks among the detected peaks. The number of higher peaks is preset. The delta bias measurer 230 outputs delta biases by computing differences between Doppler biases associated with all the satellites and the computed common bias.

The delta biases obtained for the satellites in the ideal case are 0, but satellite delta biases may have non-zero values due to a prediction error associated with a Doppler center of an AGPS message and a Doppler measurement error associated with FFT resolution. The jammer detector 232 identifies a delta bias obtained from each satellite and regards a signal with a delta bias exceeding a predetermined limit as a jammer signal or noise to remove the jammer signal or noise. For example, the limit is set to 21.9 Hz at 15 Km/h, according to the user's maximum speed in an indoor area.

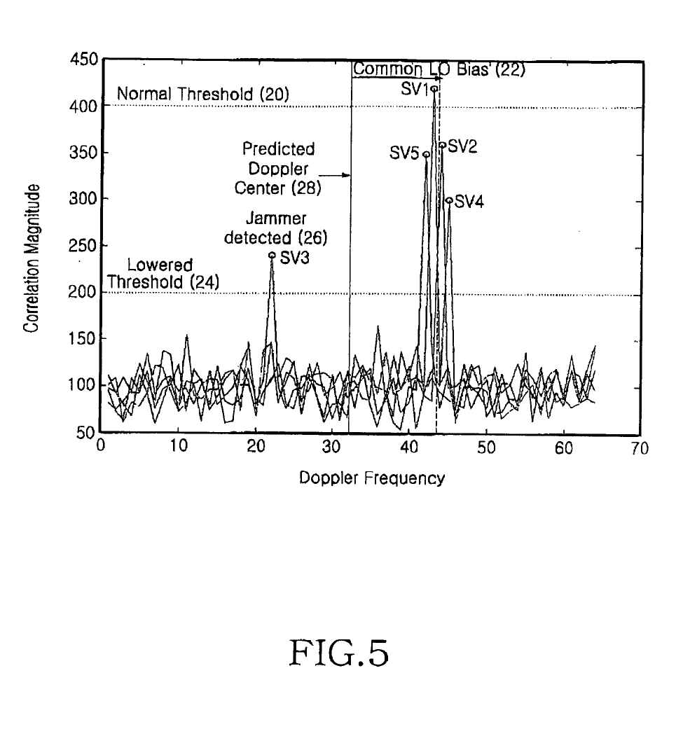

A Doppler search using an LO bias will be described with reference to FIG. 5. The example of FIG. 5 illustrates accumulated correlation values obtained by measuring 64-point FFT bins with respect to a Doppler frequency (Hz). Here, accumulated correlation values obtained by measuring signals received from five space vehicles (SVs) serving as satellites are illustrated.

In FIG. 5, a normal threshold 20 indicates an accumulated correlation value in which the probability of a false alarm is less than 0.1%, and is set to 400. A lower threshold 24 is used for the peak detector 226 of FIG. 4, and is set to 200 based on 3 dB reduction corresponding to the half value of the normal threshold 20. When the normal threshold 20 is used, a peak SV1 of only one satellite signal is detected. However, this case is not preferred. When the lower threshold 24 is used, five peaks SV1 to SV5, denoted by symbols “°”, associated with five satellites are detected. When delta biases between the five peaks and a common LO bias 22 are computed and compared with each other, SV1, SV2, SV4, and SV5 have delta biases near 0, but SV3 has a relatively large delta bias. Accordingly, SV3 is regarded as a jammer signal 26, but SV1, SV2, SV4, and SV5 are regarded as reliable measures.

The present invention reduces sensitivity loss of 3 dB by lowering a detection threshold using a relatively simple FFT structure. The probability of false alarm due to the lowered detection threshold is reduced using a delta bias, such that n-msec coherent integration can be performed using the minimum hardware. The n-msec coherent integration and the Doppler search based on resolution of 1000/2n Hz are performed without increasing hardware.

As apparent from the above description, the present invention has a number of effects.

When time consuming coherent integration is required, frequency search resolution must conventionally be high. For this, the conventional GPS receiver must increase search hardware capacity and perform a time consuming search. However, an embodiment of the present invention obtains GPS signals within a given coherent integration period without increasing the capacity of hardware for performing a search. That is, an embodiment of the present invention can perform n-msec coherent integration and a Doppler search based on resolution of 1000/2n Hz without increasing hardware requirements, such that hardware and software resources of a GPS receiver are efficiently used, reception sensitivity is improved, and the probability of a false alarm is reduced. Accordingly, an embodiment of the present invention can efficiently, accurately and rapidly detect low-level GPS signals in metropolitan areas and indoor areas, thereby rapidly and simultaneously searching many satellites.

Although embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but is defined by the following claims, along with their full scope of equivalents.

1. A method for detecting a jammer signal using fast Fourier transform (FFT) in a global positioning system (GPS) receiver, comprising:
correlating GPS signals received from GPS satellites with codes based on a plurality of carrier frequency signals having predetermined frequency offsets therebetween, and computing n correlated samples associated with each of the GPS satellites;
transforming the n correlated samples associated with each of the GPS satellites using n-point FFT to output n FFT bins;
detecting largest peaks exceeding a lowered detection threshold from the FFT bins associated with each of the GPS satellites; and
making a determination as to whether a peak relatively far away from other peaks is present among the largest peaks, and detecting, as a jammer signal, a signal of a peak far away from other peaks.

2. The method according to claim 1, wherein the lowered detection threshold is 3 dB less than a detection threshold in which false alarm probability of a jammer signal is less than 0.1%.

3. The method according to claim 1, wherein detecting the jammer signal comprises:
computing Doppler biases indicative of differences between frequencies of the peaks and a predicted Doppler center;
computing Delta biases indicative of differences between a common Doppler bias for the GPS satellites and the computed Doppler biases; and
detecting, as the jammer signal, a signal of a peak with a delta bias exceeding a predetermined limit among the delta biases.

4. The method according to claim 3, wherein the common Doppler bias is computed as an average of Doppler biases associated with a predetermined number of maximum peaks among the peaks.

5. The method according to claim 3, wherein the Doppler center is predicted by Doppler information provided from an assisted GPS (AGPS) server that receives the GPS signals from the GPS satellites.

6. A global positioning system (GPS) receiver for detecting a jammer signal using fast Fourier transform (FFT), comprising:
a correlator for correlating GPS signals received from GPS satellites with codes based on a plurality of carrier frequency signals having predetermined frequency offsets therebetween, and computing n correlated samples associated with each of the GPS satellites;
a memory for storing the n correlated samples associated with each of the GPS satellites and n FFT bins corresponding thereto;
a FFT processor for transforming the n correlated samples read from the memory using n-point FFT to obtain the n FFT bins, and transferring the n FFT bins to the memory;
a peak detector for detecting largest peaks exceeding a lowered detection threshold from the FFT bins associated with each of the GPS satellites; and
a jammer detection unit for making a determination as to whether a peak relatively far away from other peaks is present among the largest peaks, and detecting, as a jammer signal, a signal of a peak far away from other peaks.

7. The GPS receiver according to claim 6, wherein the lowered detection threshold is 3 dB less than a detection threshold in which false alarm probability of a jammer signal is less than 0.1%.

8. The GPS receiver according to claim 6, wherein the jammer detection unit comprises:
a bias measurer for computing Doppler biases indicative of differences between frequencies of the peaks and a predicted Doppler center;
a delta bias measurer for computing Delta biases indicative of differences between a common Doppler bias for the GPS satellites and the computed Doppler biases; and
a jammer detector for detecting, as the jammer signal, a signal of a peak with a delta bias exceeding a predetermined limit among the delta biases.

9. The GPS receiver according to claim 8, wherein the common Doppler bias is computed as an average of Doppler biases associated with a predetermined number of maximum peaks among the peaks.

10. The GPS receiver according to claim 8, wherein the Doppler center is predicted by Doppler information provided from an assisted GPS (AGPS) server that receives the GPS signals from the GPS satellites.
